(19) United States
(12) Patent Application Publication
(10) Pub. No.: US 2019/0073413 A1
(43) Pub. Date: Mar. 7, 2019

(54) System and Method for Producing a Media Sentiment Based Index and Portfolio of Securities

(71) Applicant: Andrew Gun-Young Kim, New York, NY (US)

(72) Inventor: Andrew Gun-Young Kim, New York, NY (US)

(21) Appl. No.: 16/119,719

(22) Filed: Aug. 31, 2018

Related U.S. Application Data
(60) Provisional application No. 62/553,482, filed on Sep. 1, 2017.

(51) Int. Cl. G06F 17/30; G06F 17/27; G06Q 40/04

(52) U.S. Cl. CPC G06F 17/30616; G06Q 40/04; G06F 17/30867; G06F 17/2705

(57) ABSTRACT

A system and process for trading securities based on sentiment, including a computer, at least one keyword related to an investor's objective, a database of tradeable securities and an index generated by tagging individual securities with at least one of the keywords, stream of news items received by the computer and a database of tagged news items created by software parsing individual news items when matching one or more of the keywords of the indexed securities, having a benchmark portfolio associated with at least one of the keywords and analyzing the database of tagged news items to detect changes in sentiment over time, having a software on identify trades minimizing the difference between investor holdings, based on at least one of the keywords, and the benchmark portfolio on a periodic basis and initiating trades and updating said holding database after initiation.

### CROSS-REFERENCE TO RELATED APPLICATIONS

This patent application claims the benefit, under 35 U.S.C. § 119(e), of U.S. Provisional Patent Application Ser. No. 62/553,482, filed on Sep. 1, 2017, the content of which is incorporated herein by reference in its entirety.

### TECHNICAL FIELD

The present invention relates generally to securities investing, and more specifically to construction and use of media sentiment data based indexes and portfolios based on such indexes.

### BACKGROUND

Conventionally, there are two schools of portfolio-based securities investing: active management and passive management. Active management focuses on selecting individual securities for a portfolio based on one or a combination of methods that include, but not limited to, economic, financial, credit, and/or technical analysis. The portfolio components and concentrations are often altered over time to better reflect the portfolio manager or portfolio management system's changing view on individual securities.

The other school, passive management, provides investors with a broader and more static exposure to a certain market, industry or investment theme. The most traditional and popular method within passive management in selecting and weighting securities for a portfolio are the ones based on market data (e.g. market capitalization and share price) and accounting data (e.g. company fundamentals). The market data based indexing has been widely used by market participants since the birth of passive management several decades ago. Since mid-2000s, alternative methods for selecting and weighting based on accounting data including the company's financials and credit profiles have also gained some popularity among the market participants for combining two distinct characteristics of active and passive management.

The disadvantages of conventional market capitalization or price based passive investing are numerous. One of the most often cited flaws is that portfolios based on those indexes tend to have more than appropriate exposures to most overvalued companies or crowded momentum stocks. In other words, securities selection and/or portfolio weighting are not based on criteria that reflect a better investment opportunity for appreciation in ever changing market environments.

Accounting data based investing aims to overcome the shortcomings of traditional market capitalization or price index based investing by utilizing more individual security specific data to select and weight the securities for a portfolio, with a view that such portfolios will outperform more traditional market capitalization or price based indexes over time. One major disadvantage of accounting data based passive investment strategy is its reliance on historical data, which can often be lagging and outdated. It has been a number of years since the first introduction of accounting data based index portfolios, and however, the results of such investing compared to traditional approaches are mixed, at best.

One of the largest benefits of passive investing is low cost exposure to a portfolio of financial securities without a burden of purchasing individual securities by investors. However, because the passive management industry has been focusing most of their product development and marketing efforts on traditional and undifferentiated products, many investors are left with little choice, outside the expensive active management industry, to invest in an innovative investment portfolio of financial securities that reflects their investment view or are tied to emerging investment trends or themes that are fast developing in this ever-changing world.

What is needed then is an improved method of selecting and weighting financial securities in a portfolio, based on an index that overcomes shortcomings of traditional indexing methodologies, that provide investors with more flexibility to have investment exposures to emerging, developing and/or unique investment trends and themes in a timely manner at a low cost.

The present invention relates generally to the passive management school of portfolio-based investing and provides a unique and differentiated method for selecting and weighting securities for indexes as well as portfolios based on an index without using any of the criteria previously used in the passive portfolio management industry such as market capitalization, share price, and accounting data. By using the present invention, investors could gain exposure to a portfolio of securities that are related to emerging and developing investment themes and trends in the market quickly, efficiently and effectively, which are not possible using any of the above mentioned conventional securities selection and weighting approaches.

### SUMMARY

The needs set forth herein as well as further and other needs and advantages are addressed by the present embodiments, which illustrate solutions and advantages described below.

The present teachings provide but are not limited to a system for trading securities based on sentiment, which include a computer, at least one keyword related to an investor's objective, a database of tradeable securities accessible by the computer and an index generated by tagging individual securities with at least one of the keywords. A stream of news items is received by the computer and the system includes a database of tagged news items created by software parsing individual news items when matching one or more of the keywords of the indexed securities. Further the system can include a benchmark portfolio associated with at least one of the keywords that analyzes the database of tagged news items to detect changes in sentiment over time. Software on the computer identifies trades minimizing the difference between investor holdings, based on at least one of the keywords, and the benchmark portfolio on a periodic basis. The computer then initiates trades and updating the holding database after initiation.

In some embodiments of the present invention, the system has at least one parameter, related to an investor's objective, received by the computer, and wherein the parameter is used to determine if identified trades are permitted trades.

In some embodiments of the present invention, the at least one parameter can be a trade value or commission.

In some embodiments of the present invention, the parameter is an aggregate of previous trades and of an estimate of future trades or include at least two investor generated keywords.

In some embodiments of the present invention the index can be published by the system.

The system according to the present teachings may be configured so that the difference between investor holdings and the benchmark portfolio is periodically updated in a continuous manner or in a scheduled manner until an objective is reached, or be based on availability of securities.

The method of the present teachings includes the system, but is not limited to a security trading system, having a plurality of holdings of a plurality of investors, each having a quantity of at least one tradeable security, a database storing the plurality of holdings according to investor identifiers, a real-time stream of news items regarding the tradeable securities, a computer receiving the news item stream and with access to the holdings database, software parsing on the computer the news stream to identify items pertinent to individual ones of the tradeable securities. The method includes analyzing parsed news items to determine buy/sell sentiment in the news stream, comparing individual ones of the plurality of holdings to determine if there is a change in sentiment for individual ones of tradeable securities in the holdings, and automatically trading securities based on the change in determined buy/sell sentiment and updating the holdings database based on the trades. A display presents the completed security trades and updated holdings to at least one of the plurality of investors.

In some embodiments of the present invention, the system can include at least one media source and at least one keyword linked to an investment theme, including selecting, using at least one data processing system, a universe of organizations tradeable securities, located in news media in relation to at least one keyword, selecting using the at least one data processing a first subset of the universe, based on a user selected time period, selecting, using at least one data processing system a sub-group of organizations from the first subset with tradeable securities based on a strength of relationship to the keyword, in the time period to be components for a Media Sentiment Based Index, weighting, using the at least one data processing system securities of the index according to a count of media articles linked to the security by the at least one keyword and creating, using the at least one data processing system, a portfolio of exchange traded securities based on the weighting.

In some embodiments of the present invention, the system can include media sentiment be weighted dependent on geography, an economic sector, a market capitalization, accounting data, or quantitative factors.

In some embodiments of the present invention the tradeable security includes interest in at least one of: a common stock, a preferred stock, a tracking stock, a depository receipt, a fixed income instrument, a credit instrument, a fund, a derivatives contract, including at least one of: a future, a forward, an option, a swap, and any other transaction relating to a fluctuation of an underlying asset or company.

In some embodiments of the present invention, the system provides for selecting, by at least one user input, the subset to avoid illiquid financial securities.

In some embodiments of the present invention, the system can include having a subset of the universe of exchange traded financial securities based on at least one of: a liquidity of the exchange traded financial securities, a size of the company of the exchange traded financial security, a number of media articles containing or searched by using the keyword(s) discussing or mentioning the exchange traded financial securities or the companies of the exchange traded financial securities, a country of incorporation of the company of the exchange traded financial security, or a country of domicile of the company of the exchange traded financial security.

The method of the present embodiment includes receiving a media based index from an index provider, wherein the index provider previously constructed a Media Sentiment Based Index (MSBI), purchasing a portfolio of exchange traded financial securities comprising the MSBI in proportion to the constituent weights of the MSBI received, altering the portfolio of exchange traded financial securities when the MSBI received from the index provider changes over time, wherein altering of the the portfolio comprises at least one of: purchasing at least one exchange traded financial security of any new constituent of the MSBI over time, purchasing additional exchange traded financial securities based on changes in the constituent weights of the constituent exchange traded financial securities making up the MSBI over time, selling at least one exchange traded financial security of any previous constituent of the MSBI over time, selling a part of constituent exchange traded financial securities based on the changes in the constituent weights of the constituent exchange traded financial securities making up the MSBI over time.

Other embodiments of the system and method are described in detail below and are also part of the present teachings.

Other features and aspects of the present invention will become apparent from the following detailed description, taken in conjunction with the accompanying drawings, which illustrate by way of example the features in accordance with embodiments of the invention. The summary is not intended to limit the scope of the invention, which is defined solely by the claims attached thereto.

### BRIEF DESCRIPTION OF THE DRAWINGS

FIG. 1 is a block diagram illustrating a system for trading securities based on sentiment.

FIG. 2 is a block diagram illustrating another embodiment of a system for trading securities based on sentiment.

FIG. 3 is a block diagram illustrating another embodiment of a system for trading securities based on media sentiment.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

The present invention provides a process, system, computer implemented method that is designed to provide investors low cost passive investment access to industry and investment trends and themes that are not currently possible by using conventional index approaches. By using an natural language processing (NLP) and search engines to identify companies and/or financial securities that have a strong direct or indirect link to keywords that represent industry/investment themes and trends such as blockchain and cryptocurrency and using the database of companies with exchange traded financial securities, an index of companies with strong economic links to emerging trends such as blockchain can be constructed, for instance. This is not possible using traditional indexing methods as the companies that use, research, develop or economically linked to the blockchain technology cannot be identified and grouped by traditional methods using market capitalization, share price, nor accounting data such as earnings and dividends as they are spread across different regions and industries, and are of varying size, financial profile and/or credit quality.

Natural Language Processing (NLP) is a technique or field of computer science, artificial intelligence, and computational linguistics concerned with the interactions between computers and human that can be used to understand human speech as it is written or spoken. By using this ability of a computer program, a large number of news media articles and reports can be analyzed and interpreted to identify and interpret media sentiment related to certain topics and keywords.

The present invention uses NLP techniques and investable securities database to identify and select a subset of companies or financial securities of the companies within the investable universe that are perceived by the media or the market to have strong ties to certain investment trends or themes.

The present invention also provides investors a new way to select and weight financial securities for a portfolio that is exposed to criteria that are not often available in widely used commercial databases such as Bloomberg and Factset. As most commercial databases that collect, clean, and store individual securities data rely heavily on historical accounting data, market data, and company filings, many investment trends and themes may not be captured by using such information and data, often lagging and outdated. For instance, there is currently little to no company that provides statistics such as percentage of financial revenue derived from the blockchain technology in 10K/Qs. Therefore, it is impossible to use accounting data based indexing methodology to construct an investable passive index portfolio tied to blockchain.

The present invention utilizes most credible and fastest news sources such as Bloomberg, Dow Jones News along with many other media sources to gather news article and report data with strong ties to keywords that define investment trends or themes and identify the companies and financial securities of the companies that are mentioned and discussed in relation to those keywords in the same media articles or reports by using natural language processing (NLP) and search engines.

The present invention uses the strength of the company's linkage to one or more keywords to select and weight components for indexes as well as portfolios of exchange traded financial securities based on indexes.

The present invention provides investors with a targeted passive investment exposure to emerging investment trends and/or themes using the NLP and search engines that have not been possible historically within the passive investment management industry. The present invention, in other words, offers investors the best of both active and passive management schools, i.e. a portfolio that presents the best investment view tied to strong investment and industry trends at a low cost.

The methods discussed above can be carried out on a computer and/or processor programmed to perform the steps of the method. In particular, the method may be carried out on a processor residing on a server in communication with mobile devices via a communications network. The method may also be carried out in a mobile browser.

Users can be connected to the system by user hardware and can transmit requests, and keywords, and a selection of functions to the system. Users can use hardware such as a computer, laptop, mobile device, smartphone, or other device for accessing the system.

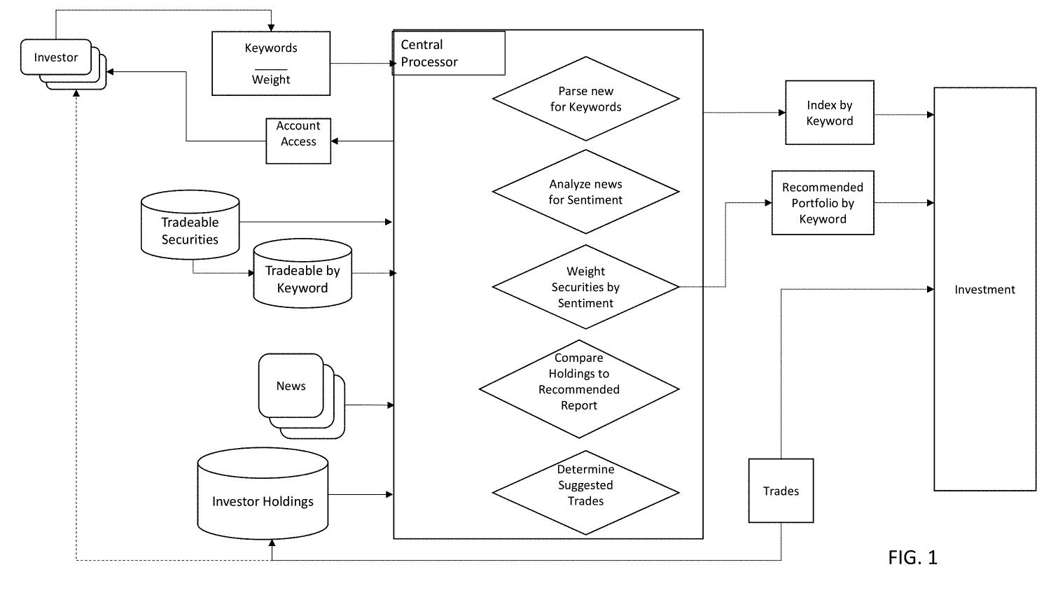

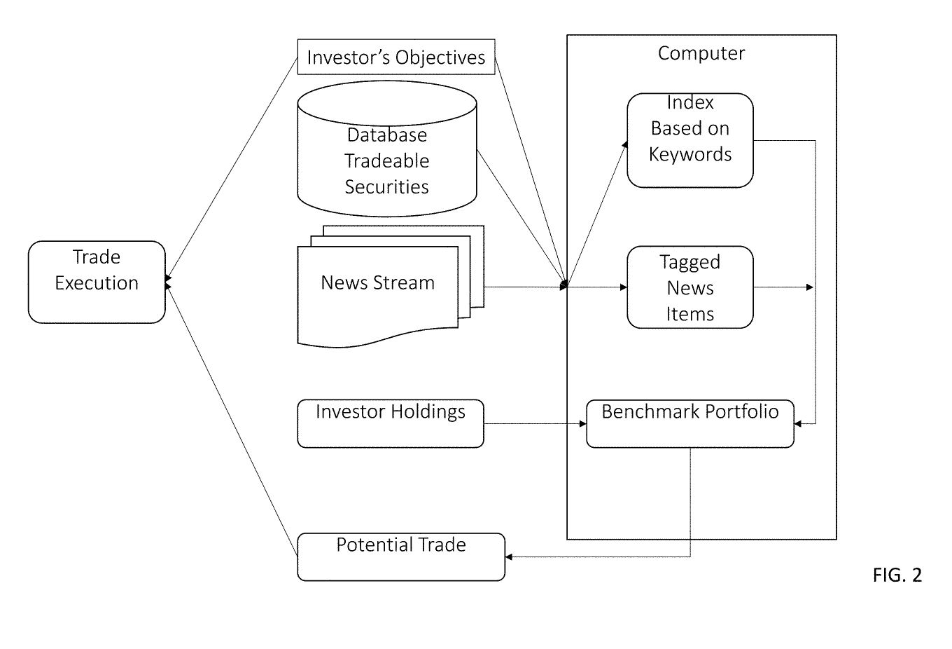

Shown in FIGS. 1 and 2 is a system for trading securities based on sentiment, which include a computer or any of the pieces of hardware mentioned above, at least one keyword related to an investor's objective, a database of tradeable securities accessible by the computer and an index generated by tagging individual securities with at least one of the keywords. The keywords can include markets or industries, or any other categorization of a company. A stream of news items is received by the computer and the system includes a database of tagged news items created by software parsing individual news items when matching one or more of the keywords of the indexed securities. The news streams can include video or audio or text format. Further the system can include a benchmark portfolio associated with at least one of the keywords and analyzing the database of tagged news items to detect changes in sentiment over time and a software to identify trades minimizing the difference between investor holdings, based on at least one of the keywords, and the benchmark portfolio on a periodic basis and initiating trades and updating the holding database after initiation. The sentiment can be measured as positive, negative or action based such buy, sell, hold, or short.

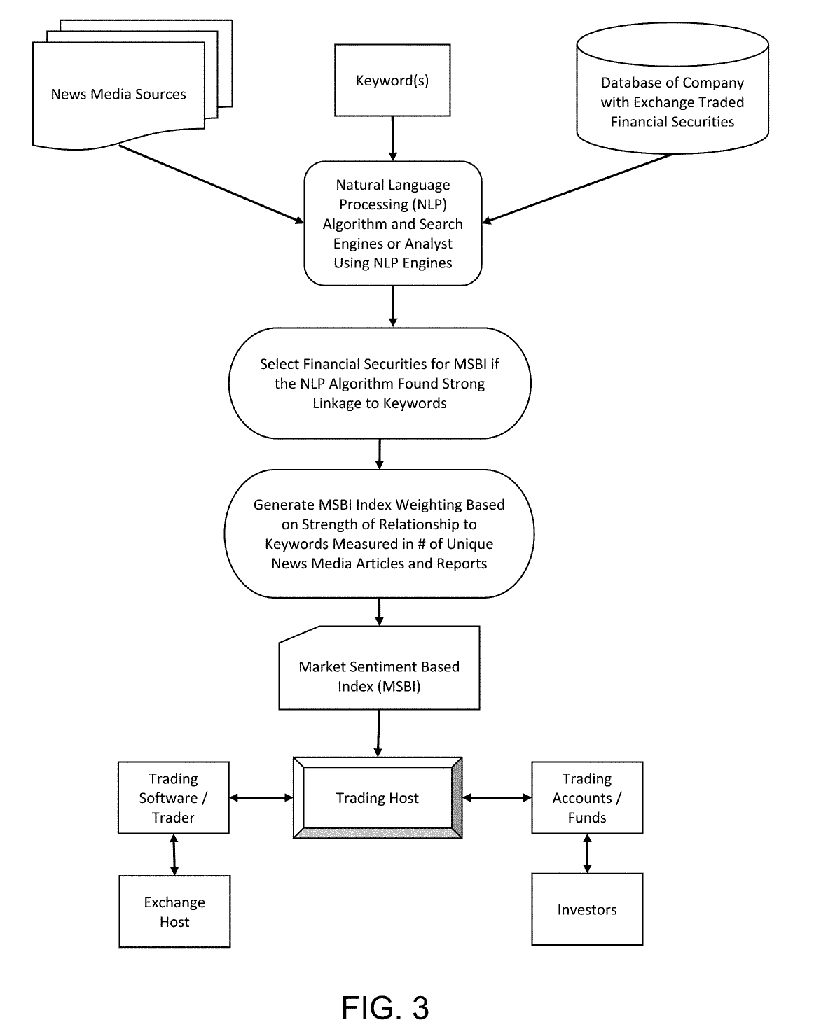

Shown in FIG. 3 is a method for creating a media sentiment-based index using at least one media source and at least one keyword linked to an investment theme, by using at least one data processing system, a universe of organizations tradeable securities, located in news media in relation to at least one keyword. Then the method can include selecting a first subset of said universe, based on a user selected time period. The user can then, using at least one data processing system select a sub-group of organizations from said first subset with tradeable securities based on a strength of relationship to said keyword for a Media Sentiment Based Index, weigh the securities of said index based on the media articles and create, using said at least one data processing system, a portfolio of exchange traded securities based on said weighting.

While the present teachings have been described above in terms of specific embodiments, it is to be understood that they are not limited to these disclosed embodiments. Many modifications and other embodiments will come to mind to those skilled in the art to which this pertains, and which are intended to be and are covered by this disclosure. It is intended that the scope of the present teachings should be determined by proper interpretation and construction of the disclosure and its legal equivalents, as understood by those of skill.

Although it is appreciated that claims are not required in a provisional application, following are non-limiting examples of claims directed to embodiments of this disclosure.

What is claimed is:

1. A system for trading securities based on sentiment, comprising:
a computer;
at least one keyword, related to an investor's objective, received by said computer;
a database of tradeable securities accessible by said computer;
an index generated by tagging individual securities of said tradeable securities with at least one of said keywords;
a stream of news items received by said computer;
a database of tagged news items created by software on said computer parsing individual news items of said news items when matching one or more of said keywords of indexed securities;
a benchmark portfolio associated at least one of said keywords created by software on said computer for analyzing said database of tagged news items to detect changes in sentiment over time;
a database of investor holdings based on at least one of said keywords;
software on said computer to identify trades minimizing the difference between investor holdings and said benchmark portfolio on a periodic basis; and
said computer initiating trades permitted by the investor and updating said holding database after initiation.

2. The system according to claim 1, further including at least one parameter, related to an investor's objective, received by said computer, and wherein said parameter is used to determine if identified trades are permitted trades.

3. The system according to claim 2, wherein said parameter is a trade value.

4. The system according to claim 2, wherein said parameter is a commission.

5. The system according to claim 2, wherein said parameter is an aggregate of previous trades and an estimate of future trades.

6. The system according to claim 2, where said parameter includes at least two investor generated keywords.

7. The system according to claim 1, wherein said index is published.

8. The system according to claim 1, wherein the periodic minimization of the difference between investor holdings and said benchmark portfolio is preselected to be continuous until an objective is reached.

9. The system according to claim 1, wherein the periodic minimization of the difference between investor holdings and said benchmark portfolio is preselected by said investor to be based on availability of securities.

10. A security trading system, comprising:
a plurality of holdings of a plurality of investors, each having a quantity of at least one tradeable security;
a database storing said plurality of holdings according to investor identifiers;
a real-time stream of news items regarding said tradeable securities;
a computer receiving said news item stream and with access to said holdings database;
software executing on said computer for:
parsing said news stream to identify items pertinent to individual ones of the tradeable securities,
analyzing parsed news items to determine buy/sell sentiment in said news stream,
comparing individual ones of said plurality of holdings to determine if there is a change in sentiment for individual ones of tradeable securities in said holdings,
automatically trading securities based on the change in determined buy/sell sentiment, and
automatically updating said holdings database based on said trades; and
a display presenting the completed security trades and updated holdings to at least one of the plurality of investors.

11. A method for creating a media sentiment-based index using at least one media source and at least one keyword linked to an investment theme, comprising:
selecting, using at least one data processing system, a universe of organizations tradeable securities, located in news media in relation to at least one keyword;
selecting, using said at least one data processing a first subset of said universe, based on a user selected time period;
selecting, using at least one data processing system a sub-group of organizations from said first subset with tradeable securities based on a strength of relationship to said keyword, in said time period to be components for a Media Sentiment Based Index;
weighting, using said at least one data processing system securities of said index according to a count of media articles linked to said security by said at least one keyword;
creating, using said at least one data processing system, a portfolio of exchange traded securities based on said weighting.

12. The method according to claim 11, wherein said media sentiment is weighted dependent on geography of said organization associated with said security.

13. The method according to claim 11, wherein said media sentiment is weighted based on an economic sector of said organization associated with said security.

14. The method according to claim 11, wherein said media sentiment is weighted based on a market capitalization of said organization associated with said exchange traded financial security.

15. The method according to claim 11, wherein said media sentiment is weighted based on said accounting data of the organization associated with said security.

16. The method according to claim 11, wherein said media sentiment is weighted based on quantitative factors of said organization associated with said security.

17. The method according to claim 11, wherein said tradeable security includes interest in at least one of:
a common stock,
a preferred stock,
a tracking stock,
a depository receipt,
a fixed income instrument,
a credit instrument,
a fund,
a derivatives contract, including at least one of:
a future
a forward
an option
a swap,
and any other transaction relating to a fluctuation of an underlying asset or company.

18. The method according to claim 11, wherein said selecting said subset include selecting, by at least one user input, said subset to avoid illiquid financial securities.

19. The method according to claim 11, further selecting a subset of said universe of exchange traded financial securities based on at least one of:
a liquidity of the exchange traded financial securities,
a size of the company of said exchange traded financial security,
a number of media articles containing or searched by using said keyword(s) discussing or mentioning the exchange traded financial securities or the companies of said exchange traded financial securities,
a country of incorporation of the company of said exchange traded financial security,
a country of domicile of the company of said exchange traded financial security.
